(19) United States
(12) Patent Application Publication
(10) Pub. No.: US 2024/0201131 A1
(43) Pub. Date: Jun. 20, 2024

(54) Native Fluorescence Detection for Protein Analysis in Capillary Electrophoresis

(71) Applicant: DH Technologies Development Pte. Ltd., Singapore (SG)

(72) Inventors: Sunil DELIWALA, Placentia, CA (US); Tingting LI, Yorba Linda, CA (US); Yagang LIU, Yorba Linda, CA (US); John SILZEL, Yorba Linda, CA (US); Zaifang ZHU, Foothill Ranch, CA (US)

(73) Assignee: DH Technologies Development Pte. Ltd., Singapore (SG)

(21) Appl. No.: 18/286,942

(22) PCT Filed: Apr. 12, 2022
(86) PCT No.: PCT/IB2022/053442

§ 371 Date: Oct. 13, 2023

Related U.S. Application Data
(60) Provisional application No. 63/292,277, filed on Dec. 21, 2021.
(60) Provisional application No. 63/174,897, filed on Apr. 14, 2021.

(51) Int. Cl. G01N 27/447

(52) U.S. Cl. CPC G01N 27/44721

(57) ABSTRACT

Methods and systems for determining concentration of a target protein in a sample using a capillary electrophoresis (CE) system are disclosed. In certain aspects, the method can include flowing a sample through a capillary tube of the CE system and utilizing a light source to generate radiation containing at least one excitation wavelength suitable for exciting at least one native fluorophore of at least one target protein in the sample. An excitation beam containing the at least one excitation wavelength can be directed onto a transparent portion of the capillary tube so as to excite said at least one native fluorophore of the target protein passing through a lumen of the transparent portion in order to cause the at least one native fluorophore to generate fluorescent radiation, and at least a portion of fluorescent radiation emitted by the excited target protein can be detected.

### RELATED APPLICATIONS

This application claims priority to U.S. Provisional Application No. 63/174,897 filed on Apr. 14, 2021, and to U.S. Provisional Application No. 63/292,277 filed on Dec. 21, 2021, the contents of which are incorporated herein in their entireties.

### TECHNICAL FIELD

The present disclosure is generally directed to systems and methods for quantification of one or more target proteins in a sample, and particularly to such quantification systems and methods that can provide high sensitivity and selectivity with the target sample contained within a capillary tube of a capillary electrophoresis (CE) system.

### BACKGROUND

Over the past two decades, capillary electrophoresis (CE) has developed into a mature separation technique for biopharmaceutical and biomolecular analysis. In the biopharmaceutical industry, CE-based techniques, including capillary electrophoresis sodium dodecyl sulfate (CE-SDS) and capillary isoelectric focusing (cIEF), are replacing gel-based electrophoretic techniques to support analytical characterization and quality control of therapeutic monoclonal antibodies (mAbs).

In CE, the use of a narrow capillary tube, to which high electric field strength can be applied, provides an environment enabling highly efficient separations using a minimal sample volume. However, the small capillary inner diameters can create a detection challenge in that they present a short optical path length, thus requiring a large sample load in order to achieve adequate sensitivity for many analytes, especially those present at low concentrations.

UV absorbance detection is the most widely used technique in CE, and has been shown to achieve a linear dynamic range of 2-3 orders of magnitude. However, its concentration sensitivity can be less than that which is required in many applications.

Laser induced fluorescence (LIF) detection is often used in an attempt to improve concentration sensitivity and extend linear dynamic range. However, commercially available excitation sources generally emit in the visible wavelength range, where proteins are not intrinsically fluorescent. In order to circumvent this LIF detection challenge, fluorophore derivatization has been used but can pose additional problems.

For example, the labeling sites on proteins have different reactivities and the labeling reaction usually produces a mixture of differentially labeled proteins, resulting in peak broadening or splitting as well as quantitation challenges. Additionally, labeling a protein with fluorescent dyes can lead to a change in the protein net charge and consequently alter the protein's isoelectric point (pI), resulting in an overall change in a protein's characteristics relative to its native state.

In an effort to circumvent the challenges posed by UV and LIF detection modalities, researchers have used deep UV lasers as an excitation source in order to take advantage of intrinsic fluorescence emission from certain amino acids to facilitate the detection and quantification of proteins. Native fluorescence detection (NFD) of proteins was first reported using a 257-nm excitation radiation, which was generated via frequency doubling of an argon-ion laser producing radiation at 514 nm. The data was obtained using a 50 μm i.d. capillary, achieving a limit of detection (LOD) of 14 nM for concalbumin.

The detection sensitivity of the same protein was improved using a 275.4 nm laser line, which was isolated from a water-cooled argon-ion laser. Pulsed lasers, including ND: YAG (266 nm), KrF (248 nm), He—Ag (224 nm) lasers, were also evaluated as excitation sources for NFD. These lasers are relatively cost-effective, but a concentration sensitivity that can be achieved using such lasers is lower than that achievable using the UV argon-ion lasers, due to unfavorable excitation wavelength and pulse-to-pulse fluctuation.

Lamps, such as xenon and deuterium lamps, provide a continuous spectrum in the deep UV region, thus allowing for flexibility in excitation wavelengths for NFD. However, conventional lamps emit divergent light of low radiant power, presenting a challenge to deliver sufficient energy for fluorescence detection in CE. In an effort to improve detection, lamp-based fluorescence detection systems have been introduced in which light from a mercury-xenon lamp is filtered and subsequently directed to the capillary via an optical fiber to be focused onto a detection cell using a ball lens. The emission fluorescence is guided along the capillary by total internal reflection to a photomultiplier tube (PMT) positioned at the end of the cell. This detection system has been successfully adapted to commercial CE instruments for analysis of various compounds. Results illustrated that the LOD for analysis of tryptophan was 6.7 nM, 20 times greater sensitivity than that obtained via absorbance detection at 214 nm. In protein analysis, LODs were in the 10-20 nM range, 25 times greater sensitivity than absorbance detection at 280 nm and comparable to absorbance detection at 214 nm. Replacing the PMT in this system with a charge-coupled device can turn the system into a wavelength-resolved fluorescence detector, which can allow for probing protein conformational changes.

There is still a need for quantification of protein samples using NFD that would provide greater sensitivity and flexible excitation wavelength relative to conventional approaches.

### SUMMARY

In accordance with various aspects of the present teachings, a system is provided for determining concentration of a target protein in a sample, which system includes a light source for generating radiation and an optical system for guiding the radiation onto a capillary tube of a capillary electrophoresis (CE) system through which a sample of interest flows so as to irradiate at least a target protein, when present in the sample. The radiation generated by the light source can comprise at least one excitation wavelength suitable for exciting at least one native fluorophore of said at least one target protein in the sample.

A variety of light sources can be used in accordance with the present teachings. For example, in some aspects, the light source can comprise at least one light emitting diode. Alternatively, in some aspects, the light source can comprises a laser driven light source. In various aspects, the light source can generate radiation with wavelengths over a spectral range, and the excitation beam can exhibit a spectral bandwidth narrower than the spectral range of the radiation. In certain aspects, the at least one excitation wavelength can be about 285 nm.

In various aspects, the capillary tube can comprise a radiation-transparent portion through which the excitation radiation can be introduced into the capillary tube and at least a portion of a fluorescent radiation generated by said target protein in response to the excitation radiation can exit the capillary tube. Additionally, in some aspects, the system can further comprise a detector optically coupled to the transparent portion of the capillary tube for receiving at least a portion of the fluorescent radiation and generating one or more fluorescent detection signals in response to detection of said received fluorescent radiation. In some related aspects, an analyzer can be in communication with the detector for receiving the detection signal(s) and for processing the detection signal(s) to obtain a concentration of said target protein in said sample. For example, the analyzer can be configured to determine the concentration of the target protein based on an intensity of said the fluorescent radiation. In some aspects, an optic can be provided for directing the fluorescent radiation onto the detector, and optionally, the optic can comprise a lens for focusing the fluorescent radiation onto the detector, and further optionally, a filter can be positioned in front of the detector to filter out excitation radiation.

In various aspects, the optical system can comprise an optical fiber extending from a proximal end to a distal end, wherein the proximal end of the optical fiber is optically coupled to the light source for receiving at least a portion of the radiation emitted thereby. In some related aspects, the system may further comprise one or more lenses disposed between the light source and the proximal end of said optical fiber for transmitting the radiation emitted from the light source to the proximal end of the optical fiber, and optionally in some aspects, the one or more lenses can comprise two convergent lenses placed in tandem so as to image an emitting surface of the LED onto the proximal end of the optical fiber. In some additional related aspects, the system can further comprise an optical filter positioned between the two convergent lenses to receive at least a portion of the radiation and select the excitation wavelength for irradiating the sample. For example, the optical filter can optionally comprise an optical bandpass or shortpass filter, and further optionally, the optical bandpass or shortpass filter can exhibit a transmission bandwidth in a range of about 270 nm to about 290 nm.

In one aspect, a system for determining concentration of a target protein in a sample is disclosed, which includes a laser driven light source for generating radiation, an optical system for guiding the radiation onto a capillary tube of a capillary electrophoresis system through which a sample of interest can flow so as to irradiate at least one target protein in the sample, wherein the radiation generated by the radiation source comprises at least one excitation wavelength suitable for exciting at least one native fluorophore of said at least one target protein in the sample.

In some embodiments, the radiation generated by the laser driven light source includes wavelengths extending over a continuous spectral range containing the excitation wavelength. In some such embodiments, the continuous spectral range may extend from about 170 nm to about 2100 nm.

The system can further include an optical filter that is positioned relative to the laser driven light source to receive at least a portion of the radiation generated by the source and select the excitation wavelength for irradiating the sample. In some embodiments, the optical filter can be an optical bandpass filter. In some such embodiments, the optical bandpass filter exhibits a transmission bandwidth in a range of about 5 nm to about 50 nm, which can be centered around the excitation wavelength.

The capillary tube can include a radiation-transmissive portion (herein also referred to as a transparent or radiation transparent portion), e.g., a portion made of glass or other suitable materials, through which the excitation radiation can be introduced into the capillary tube to excite at least one target protein of interest and through which the fluorescent radiation emitted by the excited protein can exit the capillary tube to be detected by a downstream detector. More specifically, the detector can be optically coupled to a back surface of the radiation-transmissive portion of the capillary tube for receiving at least a portion of the fluorescent radiation and generating one or more detection signals in response to the detection of the received fluorescent radiation.

In some embodiments, an optical component, e.g., a spherical mirror, is optically coupled to the transparent portion of the capillary tube to capture at least a portion of the fluorescent radiation exiting through a front portion (herein also referred to as the “front window”) of the capillary tube (i.e., the portion receiving the excitation light) and reflect the captured radiation, or at least a portion thereof, back into the capillary tube such that the reflected radiation, or at least a portion thereof, would exit through the back surface of the capillary tube to be detected by the detector. In some such embodiments, the spherical mirror can have a radius of curvature and can be positioned relative to the transparent portion of the capillary tube such that the radiation reflected thereby is focused into a focal point located in a central portion of the capillary tube. The returned fluorescent radiation can then diverge from that focal point to exit the capillary tube.

An analyzer in communication with the detector can receive the detection signals generated by the detector and can process the detection signals to compute the concentration of the target protein in the sample. By way of example, the analyzer can be configured to compute the concentration of the target protein based on the intensity of the detected fluorescent radiation.

As noted above, the laser driven radiation source can generate radiation with wavelengths (herein a wavelength of the radiation refers to a vacuum wavelength) extending over a continuous spectral range. This allows the selection of a desired excitation wavelength from among the wavelengths present in the spectral range of the radiation emitted by the source for exciting a target protein of interest. In some embodiments, a device, e.g., a filter wheel, on which a plurality of optical filters exhibiting different transmission bandwidths are mounted can be employed to switch the optical filter positioned in the path of the excitation radiation in order to select different excitation wavelengths, e.g., for detecting different target proteins. In some embodiments, the excitation wavelength can be, for example, in a range of about 200 to about 300 nm.

In some embodiments, an optical fiber, which extends from a proximal end to a distal end, is positioned relative to the optical filter and the capillary tube such that the optical fiber receives at least a portion of the excitation radiation passing through the filter via its proximal end and transmits at least a portion of the received radiation, via its distal end, onto the capillary tube for exciting at least one target protein present in the sample, or suspected of being present in the sample.

In some embodiments, an optical system configured for directing at least a portion of the excitation radiation onto the proximal end of the optical fiber can include one or more lenses for focusing the radiation into the optical fiber. In some embodiments, such lenses can include two convergent lenses placed in tandem. For example, the two lenses can be configured such that the first lens substantially collimates the incident radiation and the second lens focuses the substantially collimated radiation into the proximal end of the optical fiber. In some such embodiments, an optical filter can be positioned between the two lenses for selecting an excitation wavelength of interest.

In some embodiments, the f/number of such lenses can be selected such that the convergence angle associated with the radiation being focused onto the optical fiber (that is, the proximal end of the optical fiber) is substantially equal to the numerical aperture of the optical fiber.

In some embodiments, the system can further include an optical filter positioned between the first lens and the second lens to receive at least a portion of the radiation and select the excitation wavelength for irradiating the sample. In some such embodiments, the optical filter includes an optical bandpass or shortpass filter. By way of example, the optical bandpass or shortpass filter can exhibit a transmission bandwidth in a range of about 200 nm to about 300 nm.

In some embodiments, the laser driven light source can generate radiation with a radiance in a range of about 0.5 to about 200 mW/mm²·sr·nm. By way of example, in some such embodiments, the radiance of the emitted radiation in a vacuum wavelength range of about 200 nm to about 300 nm can be in the range of 5 to about 200 mW/mm²·sr·nm

In some embodiments, the capillary tube can have an inner diameter in a range of about 10 μm to about 200 μm, e.g., in a range of about 20 μm to about 100 μm.

In a related aspect, a method for protein analysis of a sample in a capillary electrophoresis (CE) system is disclosed, which comprises flowing a sample through a capillary tube of the CE system, utilizing a laser driven light source to generate radiation with wavelengths extending over a spectral range containing at least one wavelength suitable for exciting at least one target protein in the sample, spectrally filtering the radiation to select the excitation wavelength thereby generating an excitation beam with a spectral bandwidth that is narrower than the spectral range of the radiation generated by the laser driven radiation source and contains at least one excitation wavelength suitable for exciting at least one target protein of interest. The excitation beam is directed onto a capillary tube of a capillary electrophoresis system via a transparent portion thereof (e.g., via a radiation-transmissive window) so as to excite at least one native fluorophore of the target protein passing through the lumen of the transparent portion of the capillary tube in order to cause the fluorophore to generate fluorescent radiation, and detecting at least a portion of fluorescent radiation emitted by the excited target protein.

The emitted fluorescent radiation can be detected by directing at least a portion of the fluorescent radiation exiting the capillary tube, e.g., via a transparent section thereof (e.g., via a radiation-transmissive window), onto a detector, which generates one or more detection signals in response to the detection of the fluorescent radiation.

In some embodiments, the fluorescent radiation emitted by a plurality of different proteins is detected as a function of the migration time of those proteins, under the influence of an electric field, from an inlet of the capillary tube to the transparent portion of the tube. In some such embodiments, the distance between the inlet of the capillary tube and the transparent portion thereof can be, for example, in a range proximity of about 5 cm to about 100 cm, for example, to as to allow better resolution in separating different proteins of interest for interrogation via the excitation radiation.

In some embodiments, the radiation emitted by the laser driven radiation source can be spectrally filtered by passing the radiation through an optical filter, e.g., an optical bandpass or shortpass filter, to narrow the spectral range of wavelengths present in the radiation while ensuring that the narrowed spectral range contains the excitation wavelength of interest.

The fluorescent radiation emitted by the excited protein(s) can be analyzed to determine the concentration of the protein(s) in the sample under study. For example, the concentration of the protein of interest can be determined based on the intensity of the detected fluorescent radiation and/or the area under the fluorescent peak.

In some embodiments, in the above method for sample analysis, an optical fiber is utilized to direct the excitation radiation onto the capillary tube (that is, onto the transparent portion of the capillary tube). In such embodiments, the excitation radiation can be coupled into a proximal end of the optical fiber. The optical fiber can transmit the received radiation to its distal end. The distal end of the optical fiber is optically coupled to the transparent portion of the capillary tube such that at least a portion of the radiation exiting the distal end of the optical fiber can be introduced into the capillary tube, via its transparent portion, for exciting at least one protein flowing through the lumen of the transparent portion of the tube.

In some embodiments, the spectral range of the radiation emitted by the laser driven light source can extend, for example, from about 170 nm to about 2100 nm. Further, in some embodiments, the excitation wavelength for exciting one or more target proteins can extend from about 200 nm to about 300 nm.

In a related aspect, a system for determining concentration of a target protein in a sample is disclosed, which includes an LED light source for generating radiation; an optical fiber extending from a proximal end to a distal end, wherein the proximal end of the optical fiber is optically coupled to the LED light source for receiving at least a portion of the radiation emitted by the LED light source; a capillary tube of a capillary electrophoresis system through which a sample of interest flows, the distal end of the optical fiber being in optical coupling with a portion of the capillary tube so as to irradiate at least one target protein in the sample flowing through the capillary tube. The radiation generated by the LED light source comprises at least one excitation wavelength suitable for exciting at least one native fluorophore of the at least one target protein in the sample.

In some embodiments, the radiation generated by the LED light source has a substantially monochromic wavelength in the UV range of the electromagnetic spectrum. By way of example, the substantially monochromatic wavelength can be about 285 nm.

In some embodiments, the LED light source provides an optical power in a range of about 50 μW to about 10 mW.

In some embodiments, the capillary tube comprises a radiation-transparent portion through which the excitation radiation can be introduced into the capillary tube and at least a portion of a fluorescent radiation generated by the target protein in response to the excitation radiation can exit the capillary tube.

In some embodiments, the system can further include a detector optically coupled to the transparent portion of the capillary tube for receiving at least a portion of the fluorescent radiation and generating one or more fluorescent detection signals in response to detection of the received fluorescent radiation. In some such embodiments, an optic can be further included for directing the fluorescent radiation onto the detector. In some such embodiments, the optic comprises a lens for focusing the fluorescent radiation onto the detector. In some embodiments, a filter can be positioned in front of the detector to filter out excitation radiation.

The system can further include an optical system disposed between the LED light source and a proximal end of the optical fiber for transmitting the radiation emitted from the LED light source to the proximal end of the optical fiber. In some such embodiments, the optical system comprises one or more lenses for transmitting the radiation to the proximal end of the optical fiber. The one or more lenses can comprise two convergent lenses placed in tandem so as to image an emitting surface of the LED onto the proximal end of the optical fiber. In some embodiments, the one or more lenses comprise a first lens and a second lens, and the first lens is configured and positioned relative to the LED light source to substantially collimate the radiation generated by the LED light source, and the second lens is configured and positioned relative to the first lens to focus the collimated radiation onto the proximal end of the optical fiber.

In some embodiments, an optical filter can be positioned between the first lens and the second lens to receive at least a portion of the radiation and select the excitation wavelength for irradiating the sample. In some embodiments, the optical filter comprises an optical bandpass or shortpass filter. By way of example, the optical bandpass or shortpass filter can exhibit a transmission bandwidth in a range of about 270 nm to about 290 nm.

In accordance with various aspects of the present teachings, methods for performing protein analysis in a capillary electrophoresis (CE) system are disclosed. For example, the method for protein analysis may comprise flowing a sample through a capillary tube of the CE system and utilizing a light source to generate radiation containing at least one excitation wavelength suitable for exciting at least one native fluorophore of at least one target protein in the sample. An excitation beam containing the at least one excitation wavelength can be directed onto a transparent portion of the capillary tube of the CE system so as to excite said at least one native fluorophore of the target protein passing through a lumen of the transparent portion in order to cause the at least one native fluorophore to generate fluorescent radiation. At least a portion of fluorescent radiation emitted by the excited target protein can be detected.

A variety of light sources can be used in accordance with the present teachings. For example, in some aspects, the light source can comprise at least one light emitting diode. Alternatively, in some aspects, the light source can comprises a laser driven light source. In various aspects, the light source can generate radiation with wavelengths over a spectral range, and the excitation beam can exhibit a spectral bandwidth narrower than the spectral range of the radiation. In some related aspects, the method can further comprise spectrally filtering the radiation to generate the excitation beam. For example, an optical bandpass or shortpass filter can be utilized to spectrally filter the radiation. In some related aspects, the optical bandpass or shortpass filter can exhibit a transmission bandwidth in a range of about 200 nm to about 300 nm.

In various aspects, the target protein can comprise an antibody.

In various aspects, the at least one excitation wavelength can be about 285 nm. Additionally or alternatively, in some aspects, the method can comprise adjusting the at least one excitation wavelength contained within the excitation beam.

In certain aspects, methods in accordance with the present teachings can utilize a lens to focus the fluorescent radiation onto a detector. In some related aspects, the method may further comprise filtering the excitation wavelength from the detector

Further understanding of various aspects of the present teachings can be obtained by reference to the following detailed description in conjunction with the associated drawings, which are described briefly below.

### BRIEF DESCRIPTION OF THE DRAWINGS

FIG. 1A schematically depicts an example of a system according to an embodiment for NFD quantification of proteins in a CE system,

FIG. 1B schematically depicts a cross-sectional view of the capillary tube shown in FIG. 1A, illustrating that a high voltage applied across the capillary tube generates an electric field along the lumen of the tube, which causes the migration of proteins from an inlet of the tube to an outlet thereof,

FIG. 1C schematically depicts a filter wheel on which a plurality of optical filters having different transmission bandwidths can be mounted to allow to changing the optical filter that is positioned in the path of the radiation emitted by the radiation source and/or the fluorescent radiation,

FIG. 2 presents data indicative of signal-to-noise ratio of an example of an NFD system according to an embodiment as a function of the bias voltage applied to PMT employed in the system as a detector,

FIG. 3A presents data corresponding to CE-SDS separation of reduced SCIEX IgG control standard with NFD at excitation wavelength of 280 nm,

FIG. 3B presents data corresponding to CE-SDS separation of reduced SCIEX IgG control standard with NFD at excitation wavelength of 220 nm,

FIG. 4A presents UV absorbance data obtained using CE-SDS separation of non-reduced SCIEX IgG control standard using UV absorbance detection at 214 nm and 280 nm,

FIG. 4B presents NFD data obtained using CE-SDS separation of non-reduced SCIEX IgG control standard,

FIG. 5A presents UV absorbance detection data using cIEF separation of NIST IgG at 280 nm,

FIG. 5B presents NFD data using cIEF separation of NIST IgG at 280 nm,

FIG. 6A schematically depicts an example of a system according to another embodiment for NFD quantification of proteins in a CE system,

FIG. 6B schematically depicts an example of a system according to yet another embodiment for NFD quantification of proteins in a CE system,

FIG. 7 presents SDS-CGE separations of reduced IgG control standard with NFD using LED directly (A) and filtered LED (B) as the excitation source,

FIGS. 8A and 8B present effect of PMT control voltage on the signal-to-noise,

FIGS. 9A-9D present effect of sample injection time the detection sensitivity and separation efficiency of SDS-CGE,

FIGS. 10A and 10B present linearity of SDS-CGE with NFD for analysis of non-reduced NISTmAb, and

FIGS. 11A and 11B present quantitation and purity analysis of Etanercept in SDS-CGE with UV absorbance versus with NFD.

### DETAILED DESCRIPTION

The present disclosure is directed to systems and methods that can be employed for protein quantification in electrophoresis analysis of a variety of samples, without a need for deep UV lasers. As discussed in more detail below, in many embodiments, the systems and methods according to the present teachings allow performing NED with a sensitivity that is at least 10 times greater than that exhibited by current UV absorbance detection techniques at 214 nm. Moreover, the systems and methods of the present teachings allow adjusting the excitation wavelength, which can in turn allow optimizing the excitation wavelength for a particular target protein. Hence, in addition to high sensitivity, in many embodiments, the systems and methods according to the present teachings allow flexible selection of the excitation wavelength. For example, in many embodiments, the excitation wavelength can be adjusted by replacing a bandpass or a shortpass filter with a different filter or a monochromator without degrading the detection sensitivity. By way of example, the ability to adjust the excitation wavelength can be advantageously employed to optimize the quantum yield or can be employed for performing wavelength-resolved fluorescence detection.

Various terms are used herein according to their ordinary meanings in the art. The term “laser driven light source,” as used herein, refers to a radiation source that includes a laser that provides laser radiation for heating a gas plasma to a high temperature so as to generate radiation having wavelengths that extend over a continuous spectral region, e.g., for generating deep UV radiation, e.g., radiation with wavelengths in a range of about 200 nm to about 300 nm.

The term “about” as used herein is intended to indicate a variation of at most 10% around a numerical value.

The term “substantially” as used herein indicates a deviation, if any, from a complete state and/or condition of at most 10%, or at most 5%.

The terms “light” and “radiation” are used herein interchangeably to refer to not only to visible light but more generally to radiation in other regions of the electromagnetic spectrum, including UV radiation.

The term “radiance,” as used herein, is defined as the flux of radiation emitted per unit solid angle in a given direction by a unit area of a radiation source.

The terms “transparent,” “radiation-transmissive,” and similar terms are used herein to indicate a property of a material structure, e.g., a wall of a CE capillary tube, that allows the passage of at least 70%, or at least 80%, or at least 90% or 100% of the radiation incident thereon through the material structure.

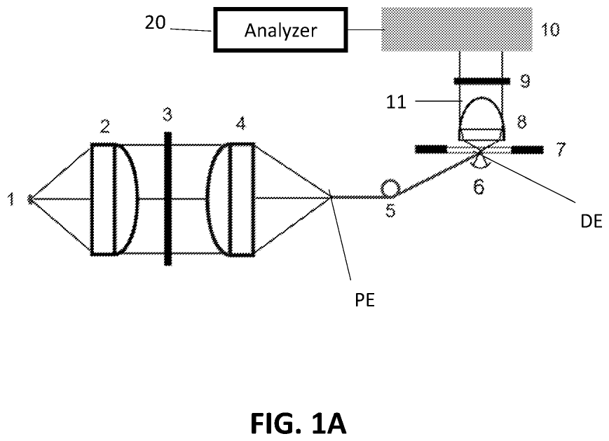

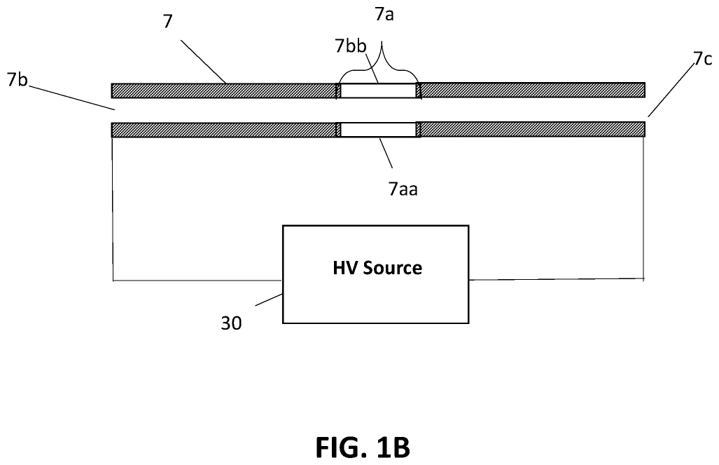

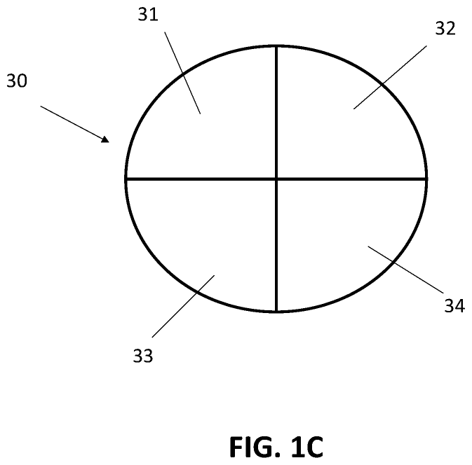

With reference to FIGS. 1A and 1B, a system 100 according to an embodiment of the present teachings for quantifying one or more target proteins in a sample flowing through a capillary tube of a CE system via laser-induced fluorescence measurements includes a radiation source 1 that can emit radiation over a spectral vacuum wavelength range extending from about 170 nm to about 2100 nm. In this embodiment, the radiation source is capable of emitting radiation having vacuum wavelengths over a range of about 200 nm to about 300 nm with a radiance over this range that is at least 10 times higher than that exhibited by conventional UV lamps over this range. By way of example, the radiation source 1 is capable of emitting radiation with a radiance in a range of about 5 to 200 mW/mm²·sr·nm. over the spectral wavelength range of about 200 nm to about 300 nm. By way of example, in some embodiments, a radiation source marketed by Energetiq Technology, Inc. of Wilmington, MA under the tradename LDLS®, which uses a laser to directly heat a xenon plasma to the high temperatures that are needed for production of deep UV radiation, can be employed.

As discussed further herein, it has been discovered that such a radiation source can be particularly useful in performing NFD analysis of proteins in a CE system.

In this embodiment, the radiation emitted by the radiation source 1 is received by a plano-convex lens 2, which is separated from the radiation source by its focal length and substantially collimates the radiation. A bandpass or a shortpass filter 3 selects a portion of the spectral range of the emitted radiation so as to generate an excitation beam having a radiation bandwidth containing at least one wavelength suitable for exciting at least one native fluorophore of at least one target protein contained in a sample, or suspected of being contained in a sample, under study, as discussed further below. Although in this embodiment the optical filter 3 is placed between the lenses 2 and 4, in other embodiments, the optical filter can be placed at other locations along the propagation path of the radiation to the sample in the capillary.

Another plano-convex lens 4 focuses the filtered radiation onto a proximal end (PE) of an optical fiber 5. In this embodiment, the f/number of the lenses 2 and 4 are selected such that the light focused onto the proximal end of the optical fiber 5 has a convergence angle that is substantially equal to the numerical aperture of the optical fiber so as to optimize the coupling of the radiation into the optical fiber.

The optical fiber 5 transmits the received radiation from its proximal end (PE) to its distal end (DE). The distal end (DE) of the optical fiber is optically coupled to a transparent portion 7a of a capillary tube 7, i.e., a portion of the capillary tube that has a transparent wall, in which a sample can flow. The transparent portion 7a provides a window through which the excitation radiation exiting the distal end of the optical fiber 5 can be introduced into the capillary tube 7 so as to excite at least one target protein when present in the sample, as the sample flows through the lumen of the transparent portion of the capillary tube. In other words, a front portion of the transparent wall of the capillary tube, i.e., the portion facing the distal end of the optical fiber, can function as a window through which the excitation radiation can enter the capillary tube.

In response to illumination by the excitation radiation, one or more native fluorophores of the target protein can emit fluorescent radiation. Native fluorescence of proteins originates from the excitation of three amino acids: phenylalanine, tyrosine, and tryptophan. It is known that the fluorescent emission intensity associated with phenylalanine is about 50 times lower than that of tyrosine or tryptophan and is generally negligible in native fluorescence detection of proteins. In most proteins, the native fluorescence is principally due to fluorescence by tryptophan residues, although some proteins can exhibit tyrosine fluorescence.

Although sensitive to the local environment, the emission peak of tryptophan is typically near 350 nm. In some embodiments, the filter 3 can be configured to allow the passage of radiation with a wavelength of 280 nm therethrough for exciting the tryptophan amino acids in the target protein. In some such embodiments, the fluorescent radiation emitted by the excited tryptophan amino acids can be collected and analyzed, e.g., in a manner discussed below, to determine the concentration of the target protein in the sample under study.

More specifically, with continued reference to FIG. 1A, in this embodiment, the emitted fluorescent radiation can exit the capillary tube through the wall of its transparent portion 7a. Some of the emitted fluorescent radiation leaves the capillary tube via a back section 7aa of the transparent portion 7a while some of the fluorescent radiation leaves the capillary tube via the front section 7bb of the transparent portion 7a.

In this embodiment, a spherical mirror 6 positioned in proximity of the transparent portion 7a of the capillary tube 7 captures at least a portion of the fluorescent radiation exiting the capillary tube and reflects the captured fluorescent radiation (or at least a portion thereof) back into the capillary tube such that the reflected fluorescent radiation (or at least a portion thereof) exits through the back section 7aa of the transparent portion 7a.

A plano-convex lens 8 is optically coupled to the transparent portion 7a of the capillary tube 7 to receive the fluorescent radiation exiting the capillary tube (or at least a portion thereof) and collimate the fluorescent radiation to generate a substantially collimated fluorescent radiation beam 11. The fluorescent radiation beam 11 passes through a bandpass filter 9 and is received by a detector 10.

By way of example, the bandpass filter allows transmission of the fluorescent radiation while blocking or reducing the passage of radiation at other wavelengths. By way of example, in some embodiments, the bandpass filter can have a transmission bandwidth that is centered at a wavelength at which the fluorescent radiation emitted by the excited target protein exhibits its maximum intensity and can have a transmission bandwidth that extends, for example, from about 5 nm to about 50 nm.

In this embodiment, the detector 10 is a photomultiplier tube, e.g., a photomultiplier tube marketed by Hamamatsu (R5984). The detector 10 generates one or more detection signals in response to the detection of the fluorescent radiation. An analyzer 20 (herein also referred to as an analysis module) receives the detection signals generated by the detector 10 and operates on those signals to compute a concentration of the target protein of interest in a sample under investigation. The analyzer 20 can be implemented in software/firmware/hardware in a manner known in the art as informed by the present teachings. In some embodiments, the instructions for analysis of the fluorescent data can be stored in a permanent memory of the analyzer and can be transferred into a transient memory module during runtime by analyzer's processor to be executed.

By way of example, in a certain concentration range (“linear dynamic range”), the protein concentration is proportional to the area of the protein UV absorption peak. In some cases, a calibration curve can be established, e.g., with 5 or more different concentrations of proteins over the range. The concentration of a target protein can then be calculated using the UV absorption peak area and the calibration curve.

It should be understood that the present teachings are not limited to determining the concentration of target proteins via excitation of tryptophan residues. For example, in some embodiments, the excitation wavelength of the system can be adjusted to detect tyrosine fluorescence, e.g., in cases in which the target proteins lack an adequate concentration of tryptophan residues.

With particular reference to FIG. 1B, a high-voltage source 30 applies a high voltage across the capillary tube 7 to generate an electric field through the capillary tube that can in turn cause different proteins present in a sample under investigation to migrate through the tube at different rates, e.g., due to differences in their mobilities. The differences of the mobilities of the proteins can be at least partially due to differences in their electrical charges. Consequently, when a sample containing different target proteins introduced into the capillary tube 7 via its inlet 7b flows, under the influence of the electric field, to the outlet 7c, the different proteins arrive at the transparent portion of the capillary tube at different times due to the differences in their mobilities. The excitation of at least one native fluorophore of each target protein can in turn allow the quantification of that protein via NFD, e.g., in a manner discussed herein, thereby allowing the quantification of various proteins in the sample.

As shown schematically in FIG. 1C, in some embodiments, a cartridge 30 containing a plurality of different optical filters 31, 32, 33, and 34 can be placed in the path of the emitted radiation, where each optical filter exhibits a different optical bandpass. The cartridge allows the selection of different excitation wavelengths for exciting different fluorophores of a plurality of target proteins. Similarly, the cartridge containing a plurality of optical filters can be placed in front of the detector 10 to allow detecting fluorescent radiation at different wavelengths.

In some embodiments, an internal standard can be added to a sample to function as a calibrant for accurate quantification of one or more target proteins present in the sample. Some examples of suitable internal standards include, without limitation, peptides and proteins with known molecular weight.

The present teachings can be employed for the detection and quantification of different types of proteins. By way of example, in some embodiments, the protein can be an antibody, such as a monoclonal or polyclonal antibody, though the present teachings can be used to quantify concentrations of other proteins in the sample, as well.

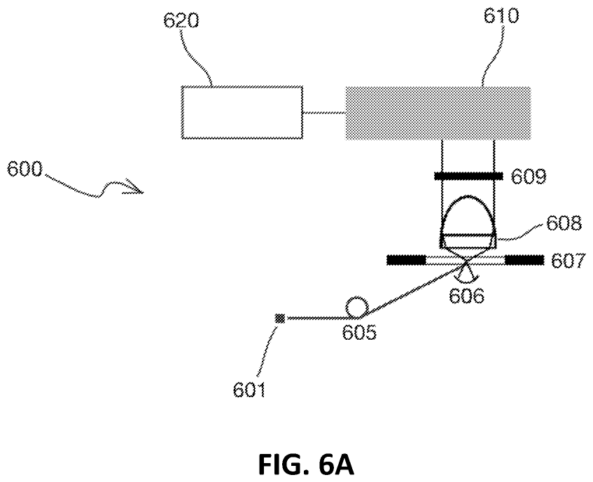

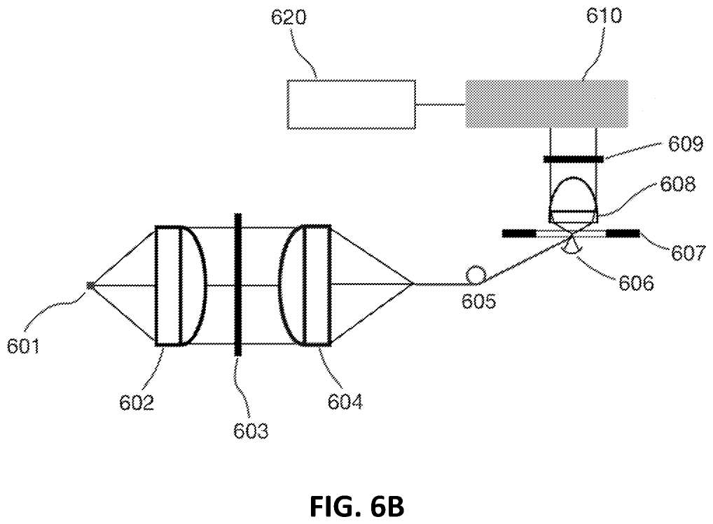

Hereinbelow, some other embodiments of a system for NFD quantification of proteins are described with reference to FIGS. 6A and 6B. More particularly, these embodiments utilize light emitting diodes (LEDs) as the light source.

Referring to FIG. 6A, a system 600 according to another embodiment of the present teachings for quantifying one or more target proteins in a sample flowing through a capillary tube of a CE system includes a light emitting diode (LED) radiation source 601 that can emit a substantially monochromic radiation in a vacuum wavelength range of about 190 nm to about 310 nm (e.g., about 285 nm). In this embodiment, the LED radiation source is capable of emitting a significantly narrower wavelength range than the laser light source discussed with regard to FIG. 1A. By way of example, in some embodiments, an LED marketed by Thorlabs, Inc., Newton, NJ, under the trade designation M280L6 can be employed. In some embodiments, the LED light source 601 can be powered by a DC power supply, which is generally included in a commercial CE system. Accordingly, the power efficiency for the system can be improved over the laser-based systems that typically require dedicated power supplies.

The LED radiation source 601 can be directly coupled to a proximal end of an optical fiber 605 via, e.g., a butt-coupling technique. Thereafter, similar to the embodiment shown in FIG. 1A, a distal end of the optical fiber 605 is optically coupled to a transparent portion 607a of a capillary tube 607, e.g., a portion of the capillary tube 607 that has a transparent wall, in which a sample can flow. The transparent portion 607a provides a window through which the excitation radiation exiting the distal end of the optical fiber 605 can be introduced into the capillary tube 607 so as to excite at least one target protein when present in the sample, as the sample flows through the lumen of the transparent portion of the capillary tube 607.

In some embodiments, a spherical mirror 606 is positioned in proximity of the transparent portion 607a of the capillary tube 607 to capture at least a portion of the fluorescent radiation exiting the capillary tube and to reflect the captured fluorescent radiation (or at least a portion thereof) back into the capillary tube 607 such that the reflected fluorescent radiation (or at least a portion thereof) exits through the back section of the transparent portion 607a.

A plano-convex lens 608 is optically coupled to the transparent portion 607a of the capillary tube 607 to receive the fluorescent radiation exiting the capillary tube 607 (or at least a portion thereof) and collimate the fluorescent radiation to generate a substantially collimated fluorescent radiation beam 611. The fluorescent radiation beam 611 passes through a bandpass filter 609 and is received by a detector 610.

In some embodiments shown in FIG. 6B, the bandpass filter 609 can have a transmission bandwidth that is centered at a wavelength at which the fluorescent radiation emitted by the excited target protein exhibits its maximum intensity and can have a transmission bandwidth that extends, for example, from about 5 nm to about 50 nm.

The detector 610 can be implemented as a photomultiplier tube, e.g., a photomultiplier tube marketed by Hamamatsu (R5984). The detector 610 can generates one or more detection signals in response to the detection of the fluorescent radiation. An analyzer 620 (herein also referred to as an analysis module) receives the detection signals generated by the detector 610 and operates on those signals to compute a concentration of the target protein of interest in a sample under investigation.

In some related embodiments, a filter (e.g., a bandpass filter) 603 can be disposed in front of the LED radiation source 601 to more precisely limit the wavelengths of the emitted radiation from the LED radiation source 601. In some such embodiments, for example, a 280 nm bandpass filter can be used. In some such embodiments, the bandpass filter 603 can have a transmission band (e.g., >65%) in a range of about 270 nm to about 290 nm. In such embodiments, as shown in FIG. 6B, the radiation emitted by the LED radiation source 601 is received by a plano-convex lens 602, which is separated from the LED radiation source by its focal length and substantially collimates the radiation.

The bandpass filter 603 or a shortpass filter rejects the residual emission in wavelengths beyond about 300 nm. Another plano-convex lens 604 focuses the filtered radiation onto a proximal end of the optical fiber 605. Although in this embodiment the bandpass filter 603 is placed between the lenses 602 and 604, in other embodiments, the bandpass filter 603 can be placed at other locations along the propagation path of the radiation to the sample flowing in the capillary tube 607.

In the embodiment shown in FIG. 6B, a spherical mirror 606, a plano-convex lens 608, a bandpass filter 609, a detector 610, and an analyzer 620 can be similarly arranged and can function similarly as the embodiments described above to excite at least one native fluorophore of at least one protein within the sample, collect and analyze fluorescent radiation emitted by the fluorophore in response to its excitation.

The following examples are provided for further illustration of various aspects of the present teachings and are not presented to indicate necessarily optimal ways of practicing the present teachings and/or optimal results that may be obtained.

### Example 1: Using a Laser Driven Light Source

A laser driven light source developed by Energetiq Technology, Inc. of Wilmington, MA, (LDLS®) was used to excite native fluorophores of several proteins in a CE system. The LDLS® generates high-intensity plasma in a xenon gas, which in turn generates radiation over a continuous spectrum ranging from 170 to 2100 nm. In the 200-300 nm region, the radiance of the generated radiation is about 10 times higher than that of traditional lamps, combined with a reported typical lifetime of about 10,000 hours. The continuous spectrum allows for greater flexibility than lasers in selection of the excitation wavelength.

The excitation wavelength was selected using a bandpass filter, which was mounted on a filter wheel and allowed interchangeable selection of different filters. A photomultiplier tube (PMT) was used as the detector. Using a 200 ng/mL tryptophan solution as a standard, the effect of the PMT bias voltage on the signal-to-noise ratio with 280 nm excitation and 333-375 nm emission was investigated. The contribution of tryptophan and tyrosine residues to the intrinsic fluorescence of a 10 kDa internal standard and reduced IgG1 was investigated by adjusting the excitation and emission wavelengths.

The developed NFD system was successfully applied to the analysis of monoclonal antibodies (mAbs) in CE-SDS, and cIEF. In CE-SDS, NFD exhibited a 15-fold improvement of concentration sensitivity relative to UV absorbance detection at 214 nm. Moreover, the detection data showed less interference by baseline fluctuations or other absorbing species. In cIEF, NFD showed 178 times greater sensitivity than UV absorbance detection at 280 nm, presumably due to decreased background of UV-sensitive carrier ampholytes.

### Reagents and Materials

An SDS-MW analysis kit, 10 kDa internal standard, IgG control standard, cIEF peptide marker kit, sample loading solution, and cIEF gel were obtained from SCIEX (Brea, CA). Tryptophan (Sigma-Aldrich, St Louis, MO) and IgG control standard (SCIEX, Brea, CA) were used to evaluate optical components and optimize parameters for the NFD prototype. USP Monoclonal IgG system suitability Reference Standard (USP IgG) was obtained from US Pharmacopeia (Rockville, MD). NISTmAb, Humanized IgGIk Monoclonal Antibody (NIST IgG) was purchased from National Institute of Standards & Technology (Gaithersburg, MD). Pharmalyte 3-10 was obtained from Cytiva (Marlborough, MA). All other chemicals were sourced from Sigma-Aldrich (St Louis, MO).

### CE-SDS Conditions

The reduced IgG standard mixture was prepared by mixing 96 μL SCIEX IgG control standard solution, 2 μL of 10 kDa internal standard, and 2 μL of 2-mercaptoethanol. The subsequent solution was then heated at 70° C. for 10 minutes in order to accelerate dissociation of non-covalently bound species and SDS-protein binding. Non-reduced SCIEX IgG control standard was also heated at 70° C. for 10 minutes before use.

All CE-SDS separations were performed using bare fused-silica capillaries (Polymicro Technologies, Phoenix, AZ) with a 50 μm i.d., a 375 μm o.d., and total/effective lengths of 30/20 cm. Prior to each separation, the capillary was sequentially rinsed with 0.1 M sodium hydroxide, 0.1 M hydrochloric acid, and DI water at 50 psi for 5, 3, and 3 minutes, respectively. SDS-MW gel buffer (SCIEX, Brea, CA) was loaded into the capillary at 50 psi for 10 minutes. Electrokinetic injection was performed at −5 kV for 10 seconds. Separations were conducted by applying a voltage of −15 kV, with 20 psi pressure at both ends to reduce the risks of forming air bubbles.

cIEF Conditions

A cIEF master mix was prepared by combining the following solutions: (1) 1 mL of 3.75 M urea in cIEF gel; (2) 60 μL of Pharmalyte 3-10; (3) 100 μL of 500 mM arginine in DI water; (4) 10 μL of 200 mM iminodiacetic acid in DI water. A NIST IgG standard mixture was prepared for UV absorbance detection by combining 200 μL cIEF mater mix, 8 μL of 4 mg/mL NIST IgG, and 2 μL each pI markers (10.0, 7.0, 9.5, and 5.5). A NIST IgG sample was prepared for NFD by diluting 150-fold with cIEF master mix.

All cIEF separations were performed using neutral coated capillaries (SCIEX, Brea, CA) with a 50 μm i.d., 375 μm o.d., and total/effective lengths of 30/20 cm. Before use, the capillary was conditioned by being rinsed with 350 mM acetic acid, DI water, and cIEF Gel (SCIEX, Brea, CA) at 50 psi for 5, 2, and 5 minutes, respectively. Prior to each separation, the capillary was rinsed at 20 psi with sample loading solution (SCIEX, Brea, CA) and water for 3 and 2 minutes, respectively. The NIST IgG sample was loaded into the capillary at 25 psi for 99 seconds. While the capillary inlet immersed into 200 mM phosphoric acid and outlet into 300 mM sodium hydroxide, focusing was performed by applying a voltage of 25 kV for 15 minutes. Replacing 300 mM sodium hydroxide with 350 mM acetic acid, chemical mobilization was performed by applying a voltage of 30 kV for 20 minutes.

### Detection System

An NFD system as described above in connection with FIG. 1A was employed for performing the measurements. The light beam from the radiation source 1 (e.g., the laser driven plasma source) was sequentially collimated using a plano-convex lens 2, filtered with a bandpass or shortpass filter 3, focused with a second plano-convex lens 4 into an optical fiber 5, and delivered to the capillary window 7 for excitation. Fluorescence emission was collimated with a plano-convex lens 8, filtered with a bandpass filter 9, and detected with a detector 10 (e.g., a photomultiplier tube (PMT)). A spherical mirror 6 was positioned proximal to the detection window to increase the collection efficiency of light emitted by analytes inside the capillary.

### Results and Discussion

### 1. PMT Voltage

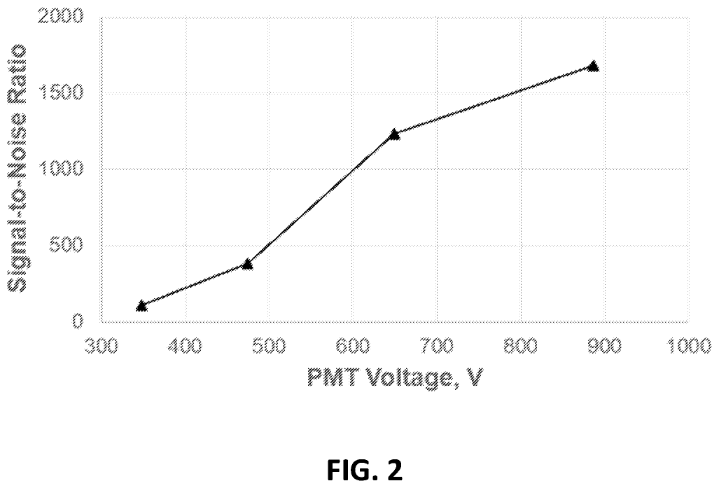

The noise was defined as the standard deviation of responses of a blank sample over a period of 20 seconds. Effect of the PMT voltage on the signal-to-noise ratio was investigated at four levels: 350 V, 475 V, 650 V, and 890 V. A 200 ng/mL tryptophan solution was injected at 0.5 psi for 5 seconds and pressure-driven separation was operated at 5 psi with water as the background. As shown in FIG. 2, the signal-to-noise ratio was enhanced from 110 to 380 when the PMT voltage increased from 350 V to 475 V. The signal-to-noise ratio was 1,229 with the PMT voltage at 650 V, and further increase of the PMT voltage to 890 V yielded a higher signal-to-noise ratio of 1,681. However, with a PMT voltage above 650 V, a 2.5 mg/mL solution of USP IgG generated a voltage signal which saturated the analog-to-digital module used (data not shown). This limited the application of the NFD scheme in this example for protein analysis at high concentration levels. As a compromise between concentration sensitivity and linear dynamic range, a PMT voltage of 650 V was selected for further experiments.

### 2. Excitation and Emission Wavelength

Native fluorescence of protein originates from the excitation of three aromatic amino acids: phenylalanine, tyrosine, and tryptophan. The emission intensity of phenylalanine is about 50 times lower than that of tyrosine or tryptophan and is generally negligible in native fluorescence detection of proteins. In most proteins, native fluorescence is principally due to tryptophan residues while some proteins exhibit tyrosine fluorescence.

Although it is sensitive to the local environment, the emission peak of tryptophan is usually near 350 nm. By adjusting the excitation and emission filters in the setup (described in connection with FIG. 1A above), the NFD measurement process was first evaluated with excitation at 280 nm and emission collected in the range of 333 to 375 nm. Reduced SCIEX IgG control standard mixed with 10 kDa internal standard was analyzed by CE-SDS using the NFD setup. The three peaks, representing IgG light chain (LC), non-glycosylated heavy chain (NGHC), and heavy chain (HC), exhibited enhanced signal-to-noise ratios relative to UV absorbance detection at 214 nm. However, the response for 10 kDa internal standard was low, presumably due to the lack of tryptophan residues.

The tyrosine emission peak was shown to be insensitive to the local environment and the emission maximum was found at around 304 nm. The contributions of tyrosine residues to native fluorescence were investigated by collecting the emission spectrum in the 305-315 nm band following excitation at 220 nm. Separation was performed in an uncoated capillary having a 50 μm i.d., 375 μm o.d., and total/effective lengths of 30/20 cm. The applied voltage was −15 kV with 20 psi pressure at both ends. The injection of the sample was achieved at a voltage of −5 kV for 10 seconds.

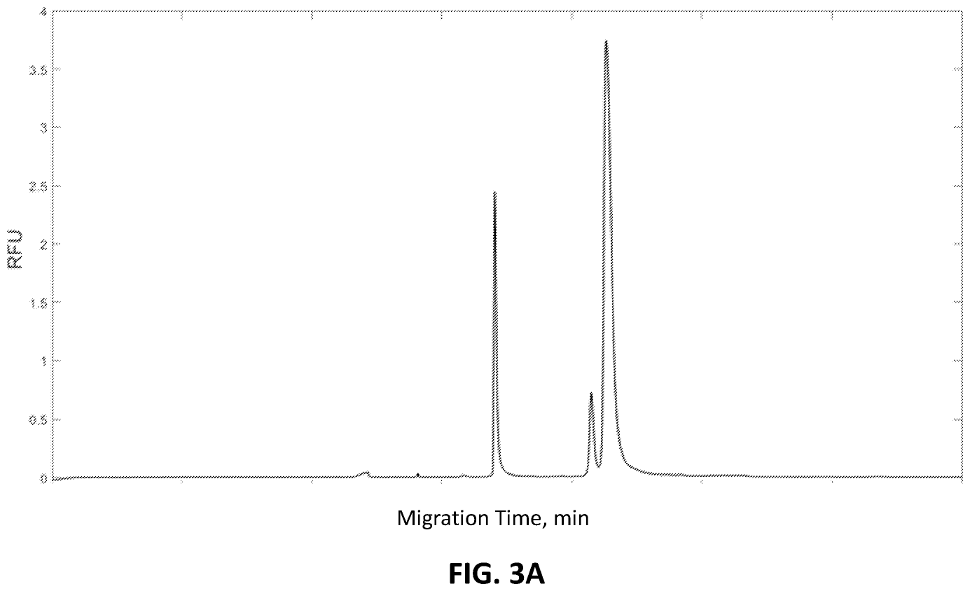

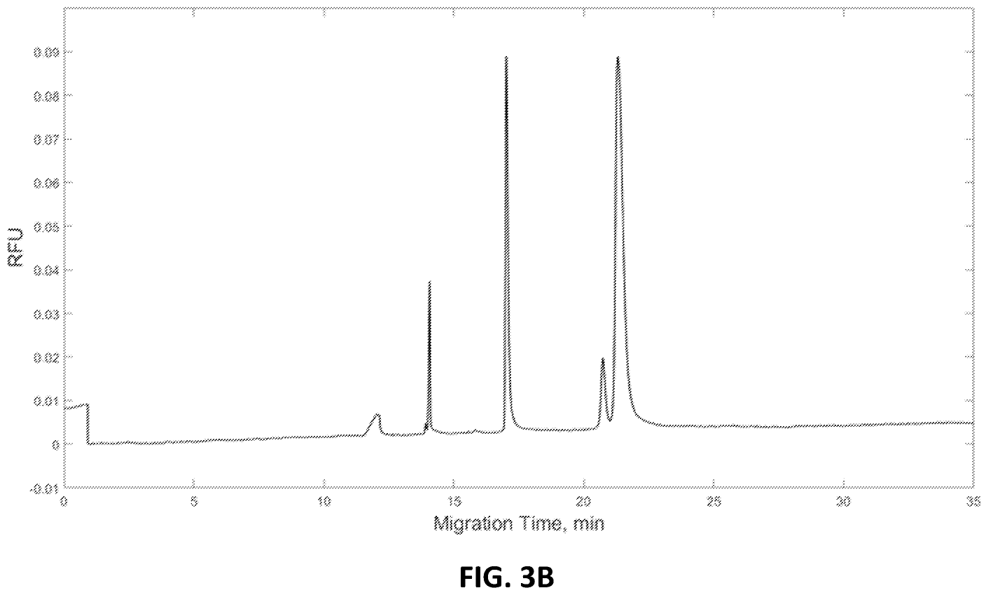

Magnitude of the 10 kDa internal standard peak was enhanced (FIG. 3B), but the three peaks representing LC, NGHC, HC were >10 times less prevalent (FIG. 3B vs. FIG. 3A). Overall tyrosine fluorescence was weak possibly due to its emission overlap with the absorption of tryptophan and energy transfer from tyrosine to tryptophan residues.

In order to maximize concentration sensitivity for CE-SDS and cIEF analysis of mAbs, NFD was employed with excitation at 280 nm and emission in the 333-375 nm band. However, the excitation and emission wavelength of the NFD system can be adjusted to detect tyrosine fluorescence in cases where target proteins lack an adequate concentration of tryptophan residues.

Analysis of mAbs Using CE-SDS with NFD

Due to its high resolution, ease of use, and high reproducibility, CE-SDS is replacing SDS-PAGE as a routine tool in the biopharmaceutical industry for the analysis of therapeutic mAbs. In CE-SDS, UV absorbance detection is often operated in the region of 210-220 nm, where maximum concentration sensitivity is achieved. However, detection is not selective and suffers from interference by other absorbing species or baseline anomalies.

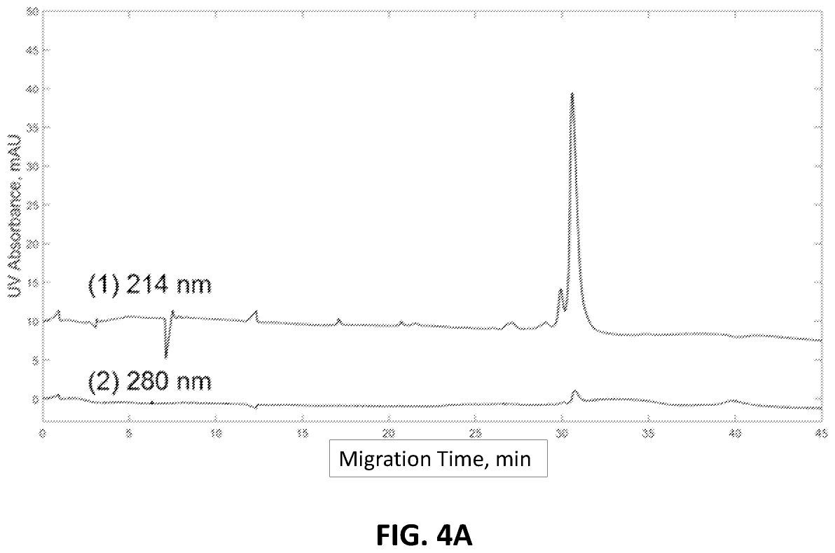

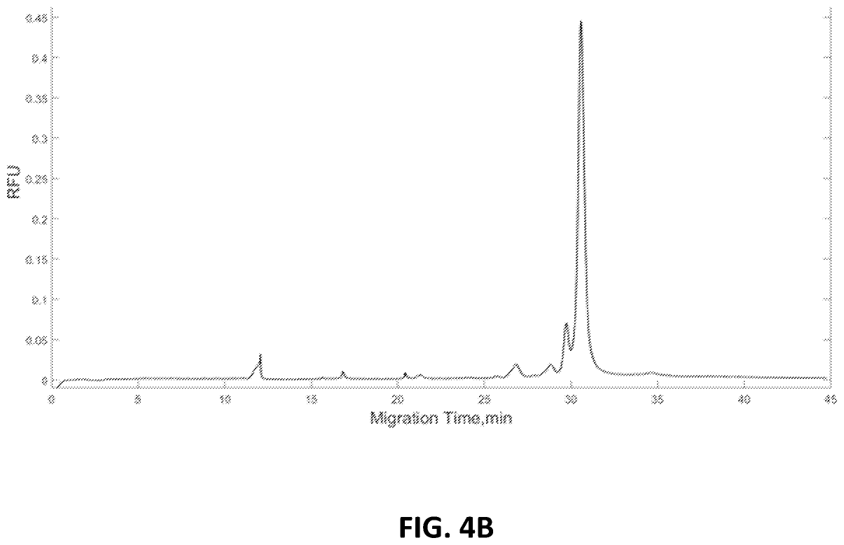

Non-reduced SCIEX IgG control standard was separated using CE-SDS with UV absorbance detection at 214 nm (See, trace 1 in FIG. 4A). The IgG sample was heated at 70° C. for 10 minutes before use. The IgG sample was directly used (FIG. 4A) and was also used with a 10-fold dilution with SDS-MW sample buffer (SCIEX, Brea, CA) (FIG. 4B). All other CE-SDS conditions were the same as those used in connection with FIG. 3.

The main peak yielded a signal-to-noise ratio of 3,389. In an attempt to eliminate the baseline anomalies, the same IgG sample was separated using CE-SDS with absorbance detection at 280 nm (See, trace 2 in FIG. 4A). However, the response was much lower and it yielded a signal-to-noise of 67 for the main peak, representing 51 times lower sensitivity than with UV absorbance detection at 214 nm (trace 2 vs. trace 1).

Using the NFD prototype system, the non-reduced SCIEX IgG control standard was diluted 10-fold with SDS sample buffer (SCIEX, Brea, CA) and analyzed (See, FIG. 4B). The signal-to-noise ratio was 5,568 for the main peak, representing 16-fold sensitivity improvement relative to UV absorbance detection at 214 nm. Additionally, the baseline exhibited less anomalies and peak integration suffered less interference than with absorbance detection at 214 nm (FIG. 4B vs. trace 1 in FIG. 4A).

Analysis of mAbs Using cIEF with NFD

cIEF separates protein molecules based on their pIs and is an important CE-based technique routinely used in the biopharmaceutical industry for mAb charge isoform analysis. In cIEF, absorbance detection is generally performed at 280 nm because carrier ampholytes tend to be UV-sensitive, especially at 214 nm. cIEF with LIF detection is not widely employed because fluorophore derivatization often can lead to a change in the charge of various protein isoforms, resulting in separation not comparable to those of their native proteins counterparts.

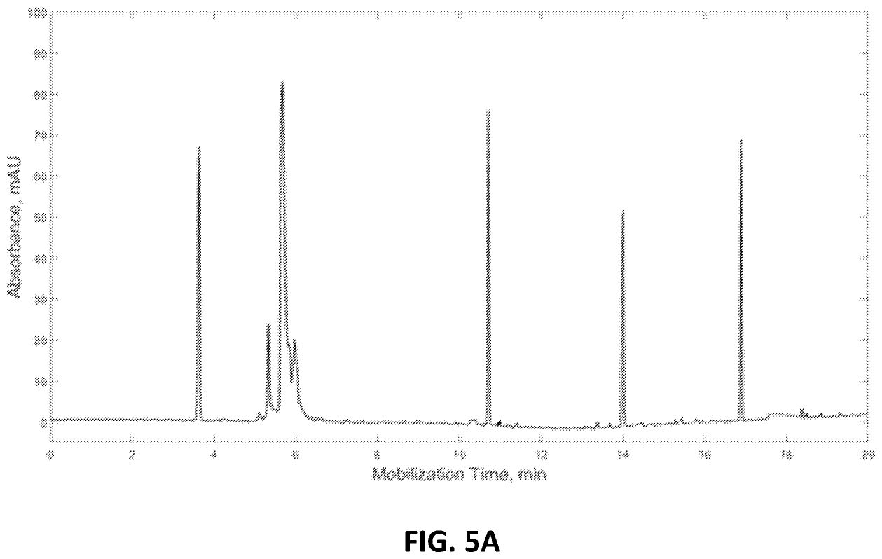

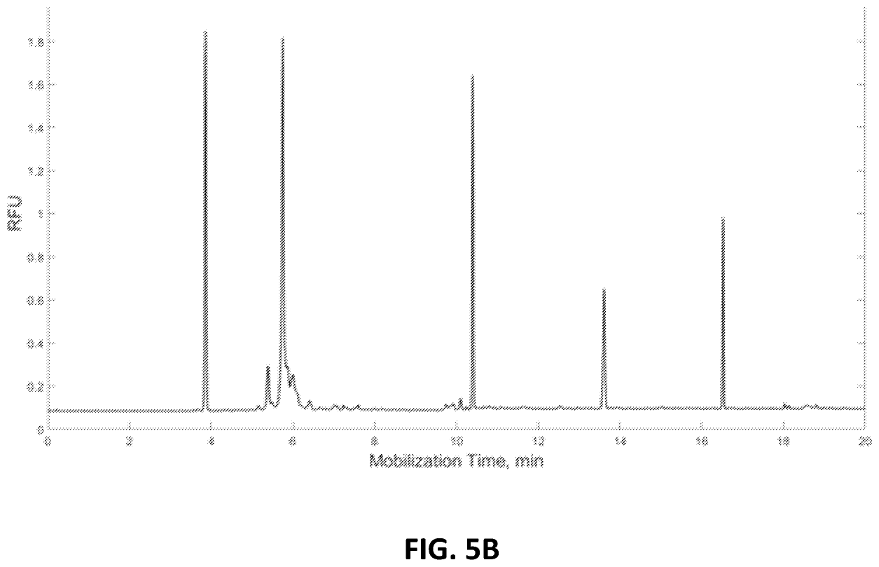

A separation of NIST IgG using cIEF with absorbance detection at 280 nm was performed (FIG. 5A). Separation was performed in a neutral coated capillary (SCIEX, Brea, CA having a 50 μm i.d., 375 μm o.d., and total/effective lengths of 30/20 cm). The NIST IgG sample was prepared as described above. For NFD, the sample used in UV absorbance detection was 150-fold diluted. Injection of the sample was achieved at 25 psi for 99 seconds, and focusing was achieved at 25 kV for 15 minutes, and chemical mobilization at 30 kV for 20 minutes.

The signal-to-noise ratio was 956 for the main peak. Using the NFD workflow, the same NIST IgG solution generated a signal that saturated the analog-to-digital module on our system (data not shown). The IgG solution was diluted 150-fold with cIEF master mix and the IgG sample yielded a signal-to-noise ratio of 1,137 (FIG. 5B). Considering 150-fold sample dilution, analysis using NFD provided 178 times sensitivity improvement for the main peak over absorbance detection at 280 nm.

### Example 2: Using an LED Light Source

A fiber-coupled 285 nm LED module was obtained from Thorlabs, Inc. (Newton, NJ). The LED light source included a single LED mounted on a metal-core circuit board, which is in direct contact with a heat sink for thermal stability. The LED was driven with a compact controller (Thorlabs, Inc., Newton, NJ), which can modulate the LED's forward DC current in the range of 0-1,200 mA. In this experiment, the LED was operated with a forward DC current of 500 mA, at which its typical lifetime is >10000 hours.

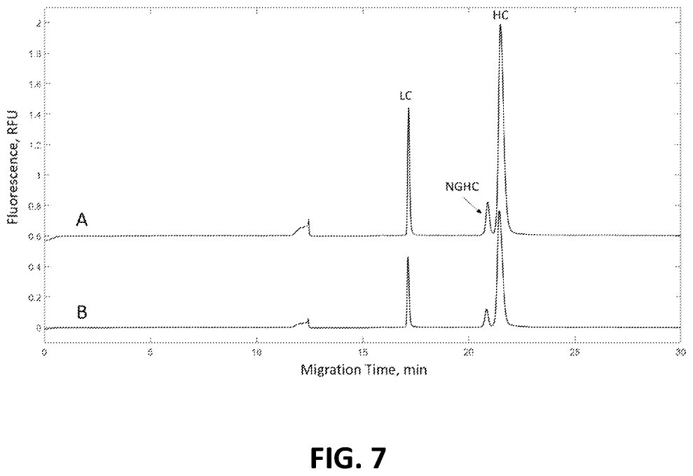

Performance of the developed NFD scheme was evaluated using an IgG control standard (SCIEX, Brea, CA), which is composed of glycosylated and non-glycosylated IgG from mouse serum. The total mass concentration is 1 mg/mL and quantity of the non-glycosylated form is ˜9.5%. The IgG sample was reduced by mixing 95 μL sample with 5 μL β-mercaptoethanol and then heating at 70° C. for 10 minutes. Before analysis, the reduced IgG control standard was 10-fold diluted with SDS sample buffer (SCIEX, Brea, CA). As shown in FIG. 7, the three peaks represent IgG light chain (LC), non-glycosylated heavy chain (NGHC), and heavy chain (HC). NGHC and HC were baseline separated, with a resolution of 1.62. Herein, the noise was defined as the standard deviation of responses of a blank sample over a period of 30 seconds. The signal-to-noise ratio (S/N) was 3240, 860, 5458 for LC, NGHC, and HC, respectively.

In order to specify LED's residual emission beyond 300 nm, fluorescence was collected in the range of 325-375 nm since residual emission in this band can significantly increase the background signal and consequentially reduce S/N. To further improve the detection sensitivity, the residual emission was rejected by collimating the light with a plano-convex lens, filtering the light through a 280 nm bandpass filter, and focusing the filtered light with a second plano-convex lens into an optical fiber, as discussed above with reference to FIG. 6B. The 280 nm bandpass filter (IDEX, Rochester, NY) exhibits a transmission of >65% in the 270-290 nm band and an average blockage >5 ODs in the 310-380 nm band. With the combination of two lenses and one optical filter, the light power received by the optical fiber decreased ˜50% and accordingly fluorescence emitted by the reduced IgG sample decreased ˜45% (see, line A vs. line B). Notwithstanding the overall decrease of the received light power, because the background signal was significantly reduced, S/N increased to 7409, 1917, and 12566 for LC, NGHC, and HC, respectively. This represents about 2.3-fold enhancement of detection sensitivity over the configuration without a 280 nm bandpass filter. Therefore, the LED light source combined with two lenses and a 280 nm bandpass filter was used for excitation in Example 2.

### Reagents and Materials

IgG control standard, SDS-MW gel separation buffer, SDS sample buffer, 0.1 N HCl acidic wash, 0.1 N NaOH basic wash, and CE grade water were from SCIEX (Brea, CA). The NIST monoclonal antibody (NISTmAb) was purchased from National Institute of Standards & Technology (Gaithersburg, MD). It is a solution of 10 mg/mL humanized IgG1ₖ monoclonal antibody in 12.5 mM L-histidine, 12.5 mM L-histidine HCl (pH 6.0). Iodoacetamide and 2-mercaptoethanol were sourced from Sigma-Aldrich (St Louis, MO). Etanercept was purchased from Myonex (Norristown, PA).

250 mM iodoacetamide was prepared by dissolving 46.2 mg in 1 mL of CE grade water (SCIEX, Brea, CA). Before use, the stock solution was diluted to 20 mM with SDS sample buffer (SCIEX, Brea, CA).

### Instrumentation

A PA800 Plus CE system (SCIEX, Brea, CA) configured with LIF detection was used in this experiment. The excitation source was designed based on a 285 nm LED (Thorlabs, Inc., Newton, NJ) and customized optics to enable compatibility with the LIF detector. The light source was powered and self-contained in the PA800 Plus CE system. All data were collected and processed with 32 Karat software (Version 10.1).

### Sample Preparation

The reduced IgG control standard was prepared by mixing 95 μL SCIEX IgG control standard solution and 5 μL 2-mercaptoethanol. The mixture was heated at 70° C. for 10 minutes and then cooled to room temperature. Before use, the sample was diluted 10-fold with SDS sample buffer (SCIEX, Brea, CA).

Non-reduced SDS-NISTmAb complexes were prepared by diluting 10 mg/mL NISTmAb to the desired concentration with SDS sample buffer (SCIEX, Brea, CA), which contained 20 mM iodoacetamide. The subsequent solution was heated at 70° C. for 10 minutes and then cooled to room temperature before use.

The 25 mg/vial Etanercept was reconstituted with 1 mL diluent, and the stock solution was diluted to the desired concentration with SDS sample buffer (SCIEX, Brea, CA), which contained 20 mM iodoacetamide. Before use, the sample solution was heated at 70° C. for 10 minutes and then cooled to room temperature.

### SDS-CGE Conditions

All SDS-CGE separations were performed using a bare fused-silica capillary (P/N 338451, SCIEX, Brea) with inner diameter (ID) of 50 μm and outer diameter (OD) of 375 μm. The capillary was installed in a cartridge (SCIEX, Brea, CA) so that the total length was 30.2 cm, with a length of 20.0 cm from the inlet to the detection window. Prior to its first use, the capillary was conditioned by rinsing with 0.1 N NaOH basic wash, 0.1 N HCl acidic wash, and CE grade water at 20 psi for 10, 5, and 2 minutes, respectively. The capillary was then filled with SDS-MW gel separation buffer at 70 psi for 10 minutes and then equilibrated by applying a voltage of −15 kV with 20 psi at both inlet and outlet ends for 15 minutes.

Before each separation, the capillary was sequentially rinsed with 0.1 N NaOH basic wash, 0.1 N HCl acidic wash, and CE grade water at 70 psi for 3, 1, and 1 minutes, respectively. SDS-MW gel separation buffer was loaded into the capillary at 70 psi for 10 minutes. The sample was electrokinetically injected into the capillary at −5 kV for 40 seconds. Separations were conducted with a voltage of −15 kV. To reduce the risks of forming air bubbles, 20 psi pressure was applied at both inlet and outlet ends during separation.

### Results and Discussion

### 1. PMT Gain

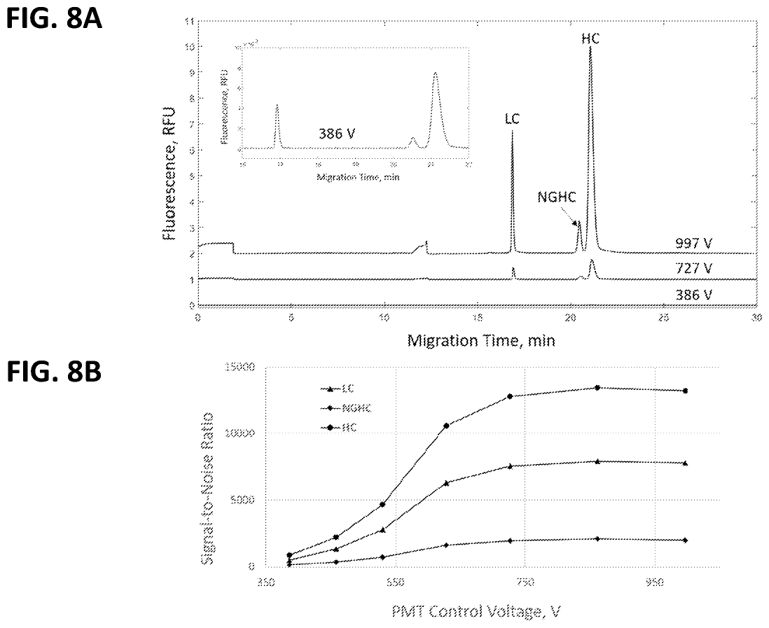

The manufacturer Hamamatsu specify the PMT maximum rating to be 1250 V. To provide reliability against voltage fluctuations, the PMT was operated with a control voltage below 1000 V, 20% lower than the specified maximum rating. In this experiment, the effect of the PMT control voltage on S/N was investigated at seven levels: 386, 458, 530, 628, 727, 862, and 997 V. 1 mg/mL IgG control standard was reduced as described above and 10-fold diluted before being analyzed in SDS-CGE. As shown in FIG. 8A, as the control voltage was increased from 386 to 727 V, the fluorescence signal increased ˜100 times. For all three peaks, representing LC, NGHC and HC, S/N was significantly enhanced (see, FIG. 8B). Further increase of the control voltage to 997 V resulted in 10-fold additional improvement of the fluorescence signal, but S/N reached a plateau. Additionally, with a PMT voltage above 727 V, a 1 mg/mL solution of IgG generated a voltage signal which is out of the input voltage range of the used analog-to-digital converter, and this limited the application of SDS-CGE with NED for protein analysis at high concentration levels. In this work, we developed a solution to quantify trace levels of impurities in mAbs samples, pursuing both detection sensitivity and linear dynamic range. Accordingly, a PMT control voltage of 727 V was selected for further experiments.

### 2. Sample Injection

In SDS-CGE, the separation gel buffer can be viscous while the sample solution can be gel-free. This mismatch often presents issues with pressure injection, and sample injection is generally performed electrokinetically. Since the SDS-denatured proteins have uniform charge-to-size ratios, regardless of their molecular weight, various protein molecules migrate in the gel-free sample solution with the same mobility, mitigating injection bias.

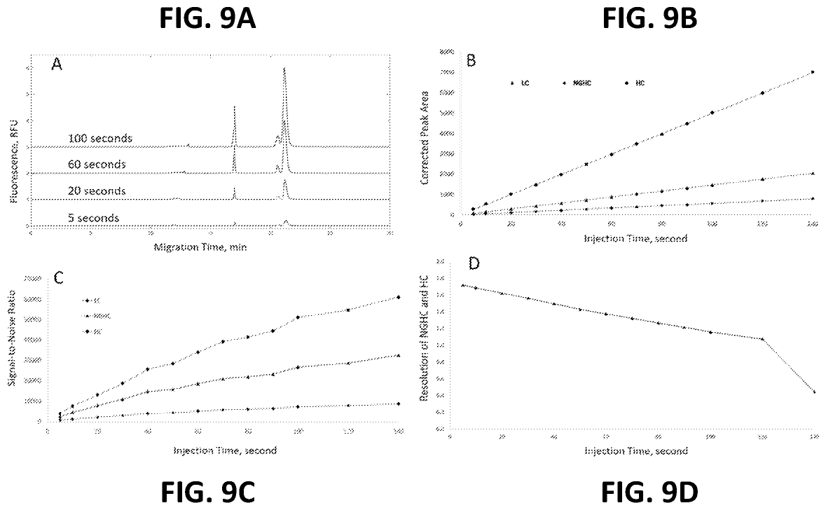

Increasing the injected amount of samples generally enhances S/N, but long sample plug injected can contribute to peak broadening and deteriorate the separation efficiency. In this experiment, the injected amount of samples was adjusted by changing the injection time from 5 to 120 seconds while the injection voltage was fixed at −5 kV. FIG. 9A shows representative electropherograms of 100 μg/mL reduced IgG samples with the injection time at 5, 20, 60, and 100 seconds. As the injection time increased, corrected peak area increased linearly with a correlation coefficient (r²) in the range of 0.9993-0.9999 (see, FIG. 9B). As shown in FIG. 9C, longer injection time resulted in a higher S/N for all three peaks, representing LC, NGHC, and HC, but it also resulted in peak broadening and decreased the separation efficiency. Resolution between NGHC and HC is <1.5 if the injection time is longer than 40 seconds (see, FIG. 9D). In the present study, sample injection was performed at −5 kV for 40 seconds to compromise between the detection sensitivity and separation efficiency of the SDS-CGE assay.

### 3. Linearity and Sensitivity

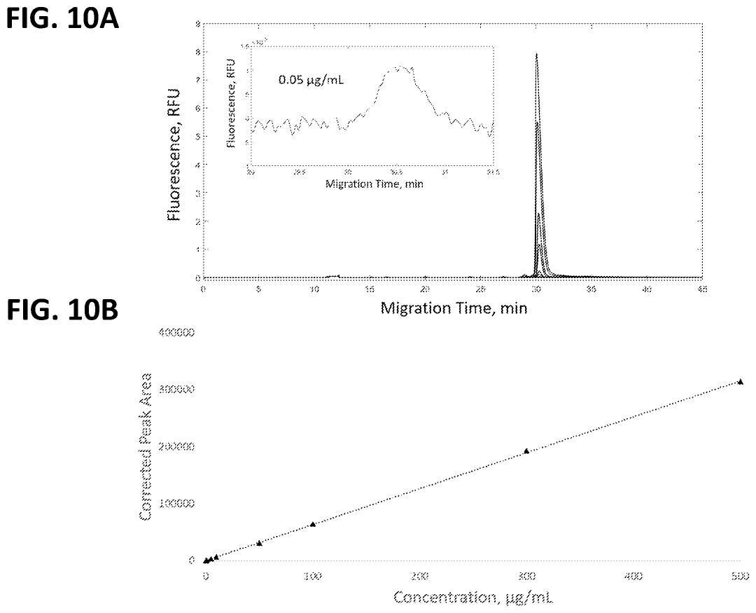

Detection of low-level impurities is one of the primary uses of SDS-CGE assays. In this experiment, the linear dynamic range of SDS-CGE with NFD was investigated using NISTmAb. The non-reduced SDS-NISTmAb complexes were prepared by diluting 10 mg/mL NISTmAb with SDS sample buffer (SCIEX, Brea, CA) containing 20 mM iodoacetamide and heating the mixture at 70° C. for 10 minutes. The non-reduced NISTmAb sample was prepared at 11 concentration levels in the range of 0.03 to 500 μg/mL, and FIG. 10A shows overlapping of their SDS-CGE electropherograms. The inset is an expanded view of the electropherogram at 0.05 μg/mL. Each sample was injected in triplicate, and linear regression was established by plotting the mean of corrected peak areas versus the concentration (see, FIG. 10B). The regression equation was y=631.63 x, where y was the corrected peak area, and x was the NISTmAb concentration. The correlation coefficient (r²) was 0.9999, indicating an excellent linear relationship between the corrected peak area and the NISTmAb concentration.

In this experiment, the limit of detection (LOD) and limit of quantitation (LOQ) were defined as the protein concentration which generates a S/N of 3 and 10, respectively. The noise was estimated by measuring the magnitude of background response of a blank sample and calculating the standard deviation of these responses over a period of 30 seconds. Under the optimized conditions, LOD and LOQ for non-reduced NISTmAb were 8.3 and 27 ng/mL, respectively. This is comparable to the concentration sensitivity obtained in SDS-CGE-LIF and SDS-PAGE with silver staining.

### 4. Precision and Accuracy

Repeatability was assessed with 18 determinations at three concentration levels, 6 determinations at each concentration. RSD for the corrected peak area was 2.35%, 0.75%, and 0.56% at 0.05, 5, and 500 μg/mL, respectively.

Because samples of impurities in NISTmAb was not obtainable, accuracy was assessed by comparing the experimental concentrations of non-reduced NISTmAb samples to their theoretical concentrations. The non-reduced IgG sample was prepared at five concentrations levels: 0.05, 0.5, 5, 50, and 200 μg/mL. Each sample was injected five times, and the mean of corrected peak areas was substituted into the regression equation to calculate the experimental concentration. As shown in Table 1, the recovery ranged from 91.5% to 104.9%.

TABLE 1

mAbs Concentration, μg/mL

| Prepared | Measured | Recovery, % |
|---|---|---|
| 0.05 | 0.04577 | 91.54 |
| 0.5 | 0.4897 | 97.94 |
| 5 | 5.035 | 100.7 |
| 50 | 49.31 | 98.63 |
| 200 | 209.7 | 104.9 |

### 5. Application of SDS-CGE-NFD to Quantitation and Purity Analysis of Etanercept

Etanercept is a therapeutic Fc-fusion protein, approved by FDA in 1998 to treat psoriatic arthritis and rheumatoid arthritis. It is highly glycosylated and with an apparent molecular weight of ˜150 kDa. To evaluate purity and the high-molecular-weight (HMW) content in Etanercept and its biosimilar, Cho et al. (Cho et al., “Evaluation of the structural, physicochemical, and biological characteristics of SB4, a biosimilar of etanercept. mAbs,” 2016, 8 (6), 1136-1155) employed size exclusion chromatography-multi-angle laser light scattering (SEC-MALLS) and the determined HMW content in the reference product was 2.3-3.1%. However, due to poor SEC separation of the main and low-molecular-weight (LMW) species, quantitation of the LMW content in SEC-MALLS was not accurate and it was achieved using SDS-CGE-UV.

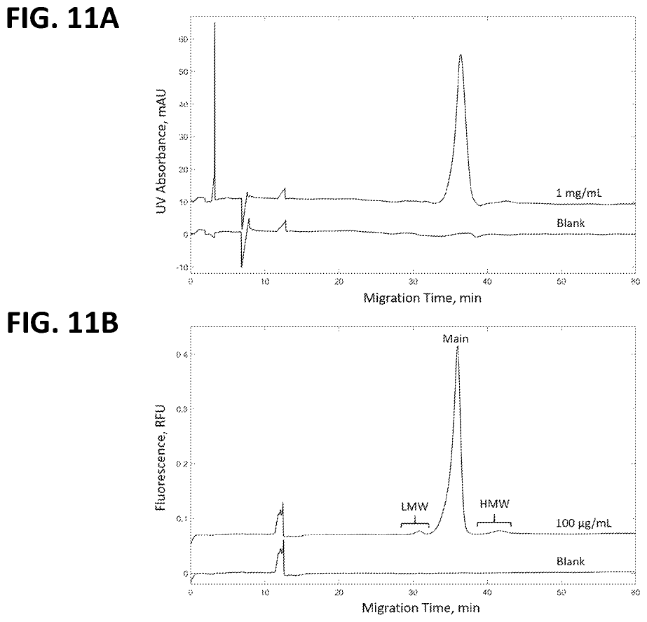

While absorbance detection in the 214 nm region is the most widely utilized detection strategy in SDS-CGE, it is not selective and often suffers from interference by baseline anomalies. FIG. 11A shows the SDS-CGE-UV electropherogram of 1 mg/mL non-reduced Etanercept. The baseline waviness around the main peak complicated peak integration and posed challenges in purity analysis of Etanercept, especially in the HMW region.

NFD eliminated the baseline anomalies and provided enhanced concentration sensitivity. FIG. 11B shows the SDS-CGE-NFD electropherogram of 100 μg/mL non-reduced Etanercept. The HMW and LMW peaks were both well distinguished from the noise and baseline fluctuation, allowing for quantitation of HMW and LMW content using a single assay. The percentage of corrected peak area was as shown in Table 2. The determined HMW content was consistently in the range of 2.57-2.63%, comparable to the reported HMW content in a reference product analyzed with SEC-MALLS. The LMW content was determined to be 1.19-1.27%, consistent over the range of 50-150% of the target concentration (200 μg/mL).

TABLE 2

| Etanercept Concentration, | | | | | |
|---|---|---|---|---|---|
| μg/mL | | | % Corrected Peak Area | | |
| Prepared | Measured | Recovery, % | LMW | Main | HMW |
| 100 | 97.12 | 97.12 | 1.20 | 96.17 | 2.63 |
| 150 | 145.7 | 97.13 | 1.19 | 96.24 | 2.57 |
| 200 | 194.1 | 97.02 | 1.24 | 96.14 | 2.62 |
| 250 | 252.7 | 101.1 | 1.27 | 96.16 | 2.57 |
| 300 | 304.9 | 101.6 | 1.25 | 96.15 | 2.60 |

A calibration curve was established over the range of 50-150% of the target concentration, 200 μg/mL, for the main peak. The regression equation was y=353.43 x, where y represented the corrected peak area and x represented the Etanercept concentration. The correlation coefficient (r²) was 0.9990, indicating good linearity of the SDS-CGE-NFD method for quantitation of Etanercept. The mean of corrected peak areas was substituted into the regression equation to calculate the experimental concentration, and recoveries were in the range of 97.02-101.6%.

Those having ordinary skill in the art will appreciate that various changes can be made to the above embodiments without departing from the scope of the present teachings.

What is claimed is:

1. A method for protein analysis of a sample in a capillary electrophoresis (CE) system, comprising:
flowing the sample through a capillary tube of the CE system;
utilizing a light source to generate radiation containing at least one wavelength suitable for exciting at least one native fluorophore of at least one target protein in the sample;
directing an excitation beam containing the at least one excitation wavelength onto a transparent portion of the capillary tube of the CE system so as to excite said at least one native fluorophore of the target protein passing through a lumen of the transparent portion in order to cause the at least one native fluorophore to generate fluorescent radiation; and
detecting at least a portion of fluorescent radiation emitted by the excited target protein.

2. The method of claim 1, wherein the light source comprises at least one light emitting diode (LED), or wherein the light source comprises a laser driven light source.

3. (canceled)

4. The method of claim 1, wherein the light source generates radiation with wavelengths over a spectral range, and wherein the excitation beam exhibits a spectral bandwidth narrower than the spectral range of the radiation.

5. The method of claim 4, further comprising spectrally filtering the radiation to generate the excitation beam, wherein, optionally, the spectrally filtering the radiation comprises utilizing an optical bandpass or shortpass filter.

6. (canceled)

7. The method of claim 6, wherein said optical bandpass or shortpass filter exhibits a transmission bandwidth in a range of about 200 nm to about 300 nm.

8. The method of claim 1, wherein the target protein comprises an antibody.

9. The method of claim 1, wherein the at least one wavelength is about 285 nm.

10. The method of claim 1, further comprising utilizing a lens to focus the fluorescent radiation onto a detector, and optionally, further comprising filtering the excitation wavelength from the detector.

11. (canceled)

12. The method of claim 1, further comprising adjusting the at least one excitation wavelength contained within the excitation beam.

13. A system for determining concentration of a target protein in a sample, comprising:
a light source for generating radiation,
an optical system for guiding the radiation onto a capillary tube of a capillary electrophoresis system through which a sample of interest flows so as to irradiate at least a target protein, when present in the sample,
wherein the radiation generated by the light source comprises at least one excitation wavelength suitable for exciting at least one native fluorophore of said at least one target protein in the sample.

14. The system of claim 13, wherein the light source comprises at least one light emitting diode (LED), or wherein the light source comprises a laser driven light source.

15. (canceled)

16. The system of claim 13, wherein the light source is configured to generate radiation with wavelengths over a spectral range, wherein the excitation beam exhibits a spectral bandwidth narrower than the spectral range of the radiation, and, optionally, wherein the at least one excitation wavelength is about 285 nm.

17. (canceled)

18. The system of claim 13, wherein said capillary tube comprises a radiation-transparent portion through which the excitation radiation can be introduced into the capillary tube and at least a portion of a fluorescent radiation generated by said target protein in response to the excitation radiation can exit the capillary tube.

19. The system of claim 18, further comprising a detector optically coupled to said transparent portion of the capillary tube for receiving at least a portion of the fluorescent radiation and generating one or more fluorescent detection signals in response to detection of said received fluorescent radiation.

20. The system of claim 19, further comprising an optic for directing said fluorescent radiation onto the detector, and optionally, wherein said optic comprises a lens for focusing the fluorescent radiation onto the detector, and further optionally, further comprising a filter positioned in front of said detector to filter out excitation radiation.

21. The system of claim 19, further comprising an analyzer in communication with said detector for receiving said one or more detection signals and processing said detection signals to obtain a concentration of said target protein in said sample.

22. The system of claim 21, wherein said analyzer is configured to determine said concentration of the target protein based on an intensity of said detected fluorescent radiation.

23. The system of claim 13, wherein the optical system comprises an optical fiber extending from a proximal end to a distal end, wherein said proximal end of the optical fiber is optically coupled to said light source for receiving at least a portion of the radiation emitted thereby.

24. The system of claim 23, further comprising one or more lenses disposed between said light source and the proximal end of said optical fiber for transmitting the radiation emitted from said light source to said proximal end of said optical fiber, and optionally, wherein said one or more lenses comprise two convergent lenses placed in tandem so as to image an emitting surface of the LED onto the proximal end of the optical fiber.

25. The system of claim 24, further comprising an optical filter positioned between said two convergent lenses to receive at least a portion of the radiation and select said excitation wavelength for irradiating said sample, and optionally, wherein said optical filter comprises an optical bandpass or shortpass filter, and further optionally, wherein said optical bandpass or shortpass filter exhibits a transmission bandwidth in a range of about 270 nm to about 290 nm.
